(19) United States
(12) Patent Application Publication
(10) Pub. No.: US 2012/0026057 A1
(43) Pub. Date: Feb. 2, 2012

(54) ANTENNA DEVICE

(75) Inventor: Masao TESHIMA, Kunitachi-shi (JP)

(73) Assignee: KABUSHIKI KAISHA TOSHIBA, Tokyo (JP)

(21) Appl. No.: 13/193,989

(22) Filed: Jul. 29, 2011

(30) Foreign Application Priority Data
Jul. 30, 2010 (JP) 2010-172209

(51) Int. Cl. H01Q 21/00

(52) U.S. Cl. 343/843; 343/893

(57) ABSTRACT

According to one embodiment, an antenna device includes a linear first antenna element, a linear second antenna element and a linear third antenna element. One end of the first antenna element is connected to a feeding point. One end of the second antenna element is connected to the feeding point. A length of the second antenna element is shorter than a length of the first antenna element. One end of the third antenna element is connected onto the first antenna element. A length of the third antenna element is shorter than the length of the first antenna element.

### CROSS-REFERENCE TO RELATED APPLICATIONS

This application is based upon and claims the benefit of priority from Japanese Patent Application No. 2010-172209, filed Jul. 30, 2010; the entire contents of which are incorporated herein by reference.

### FIELD

Embodiments described herein relate generally to an antenna device applied to, for example, a personal computer with a wireless communication function.

### BACKGROUND

In recent years, an easy-to-carry, battery-powered, notebook-size personal computer has become widely used. Public wireless local area network (LAN) services known as hot spot services are beginning to be offered in various regions. Against this background, many personal computers of this type include a wireless communication function of executing wireless communication with a wireless LAN access point (AP). In addition, nowadays, it is becoming common practice for a personal computer to be equipped with a wireless communication function of executing wireless communication with an external device according to a third-generation (3G) mobile communication method.

As the number of types of wireless communication methods increases, the wireless communication functions of personal computers of this type are required to support a plurality of wireless communication methods. To meet the requirement, various mechanisms for covering a plurality of resonant frequency bands with a single antenna (for multiple resonance) have been proposed.

For example, an antenna device that covers three resonant frequency bands is well known. The antenna device includes a first antenna element connected to a feeding point and a second antenna element connected to the first antenna element at a point located near the feeding point. In the antenna device with such a configuration, (1) antenna current flows mostly over the first antenna element at a first resonant frequency, (2) antenna current flows mostly over the second antenna element at a second resonant frequency, and (3) antenna current flows mostly over the first antenna element at a third resonant frequency. The third resonant frequency is a triple harmonic of the first resonant frequency.

Therefore, when the length of the first antenna element is changed, not only the first resonant frequency but also the third resonant frequency changes. That is, an antenna device with the aforementioned configuration has the problem of being incapable of adjusting the first and third resonant frequencies independently.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an external appearance of an information processing apparatus equipped with an antenna device according to an embodiment.

FIG. 2 is an exemplary view showing a system configuration of the information processing apparatus equipped with the antenna device of the embodiment.

FIG. 3 is an exemplary view showing a configuration of the antenna device according to the embodiment.

FIG. 4 is an exemplary view showing a characteristic (VSWR) of the antenna device according to the embodiment.

FIG. 5 is an exemplary view showing a configuration of a general antenna device.

FIG. 6 is an exemplary view showing a characteristic (VSWR) of the general antenna device.

FIG. 7 is an exemplary view showing current distribution for an antenna element at each resonant frequency in the general antenna device.

FIG. 8 is an exemplary view showing current distribution for the antenna element at each resonant frequency in an antenna device of the embodiment.

FIG. 9 is an exemplary view showing a characteristic (VSWR) of the antenna device of the embodiment when the length of each element is changed.

FIG. 10 is an exemplary diagram to explain a first element length, a second element length, and a third element length in FIG. 9.

FIG. 11 is an exemplary diagram to explain the way a second resonant frequency is replaced with a third resonant frequency in the antenna device of the embodiment.

FIG. 12 is an exemplary view showing a first modification of the configuration of the antenna device of the embodiment.

FIG. 13 is an exemplary view showing a second modification of the configuration of the antenna device of the embodiment.

FIG. 14 is an exemplary view showing a third modification of the configuration of the antenna device of the embodiment.

FIG. 15 is an exemplary view showing a fourth modification of the configuration of the antenna device of the embodiment.

FIG. 16 is an exemplary view showing a fifth modification of the configuration of the antenna device of the embodiment.

### DETAILED DESCRIPTION

Various embodiments will be described hereinafter with reference to the accompanying drawings.

In general, according to one embodiment, an antenna device includes a linear first antenna element, a linear second antenna element and a linear third antenna element. One end of the first antenna element is connected to a feeding point. One end of the second antenna element is connected to the feeding point. A length of the second antenna element is shorter than a length of the first antenna element. One end of the third antenna element is connected onto the first antenna element. A length of the third antenna element is shorter than the length of the first antenna element.

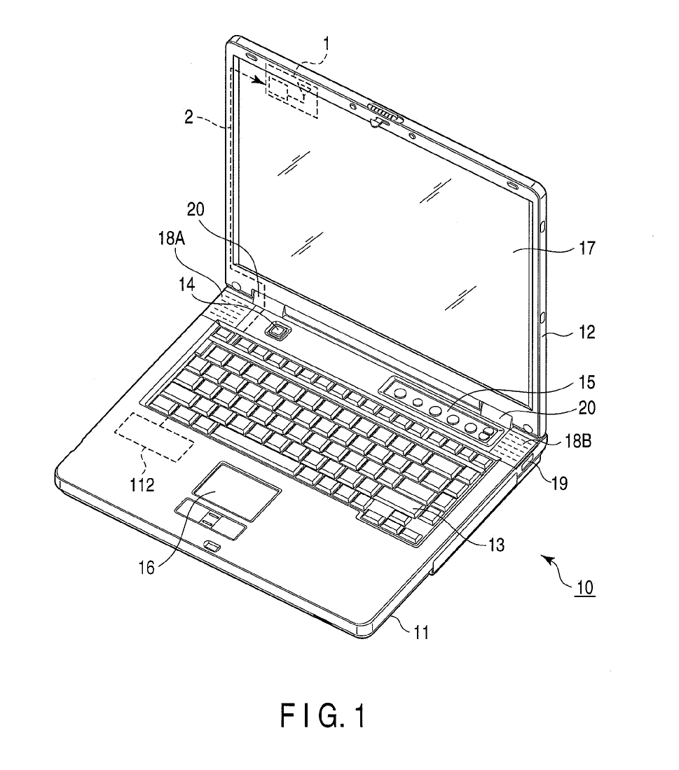

FIG. 1 is an exemplary view showing an external appearance of an information processing apparatus equipped with an antenna device according to an embodiment. The information processing apparatus is realized by, for example, a battery-powered portable personal computer 10.

FIG. 1 is an exemplary perspective view of the computer 10, with its display unit opened. The computer 10 includes a computer main body 11 and a display unit 12. A liquid-crystal display (LCD) 17 is incorporated in the display unit 12. The display screen of the LCD 17 is located roughly in the center of the display unit 12.

The display unit 12 is arranged on the computer main body 11 so as to turn freely via a hinge unit 20. The hinge unit 20 is a coupling unit that couples the display unit 12 with the computer main body 11. That is, the display unit 12 is supported by the hinge unit 20 arranged at the back-end part of the computer main body 11. The display unit 12 is arranged on the computer body with the hinge unit 20 so as to turn freely between an open position at which the top face of the computer main body 11 is exposed and a closed position at which the top face of the computer body is covered with the display unit 12.

The antenna device 1 of the embodiment is arranged in the display unit 12. The antenna device 1 covers a first to a third resonance frequency band. A signal line 2 directed from a wireless communication module 112 arranged in the computer main body 11 into the display unit 12 via the hinge unit 2 is connected to the antenna device 1.

The computer main body 11 is a base unit that has a thin box chassis. On the top face of the computer main body 11, there are arranged a keyboard 13, a power button 14 for turning on and off the computer 10, an input operation panel 15, a touchpad 16, speakers 18A, 18B, and others. On the input operation panel 15, various operation buttons are arranged. In the computer main body 11, there is arranged a system board (also referred to as a motherboard) on which various electronic parts are mounted. The wireless communication module 112 is arranged on the system board. The wireless communication module 112 is a module that executes wireless communication with an external device according to, for example, a third-generation (3G) mobile communication method.

The mounting position of the antenna device 1 is, for example, in the top end part of the display unit 12. Arranging the antenna device 1 in the top end part of the display unit 12 enables the wireless communication module 112 to execute wireless communication with an external device, with the antenna device 1 located in a relatively high position.

On the right side surface of the computer main body 11, there is arranged a Universal Serial Bus (USB) connector 19 for connecting a USB cable or a USB device complying with, for example, the USB 2.0 standard.

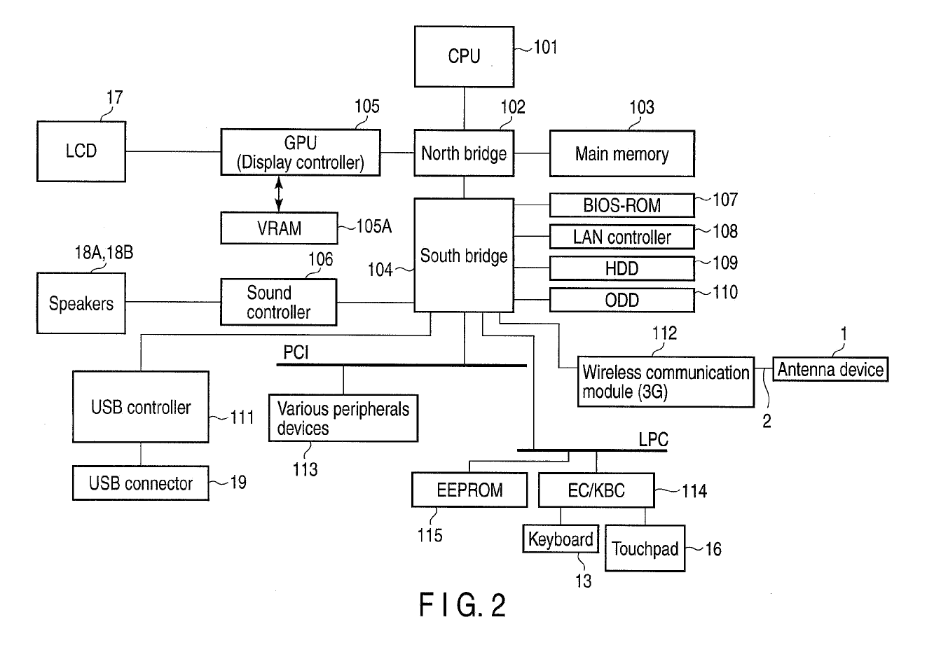

FIG. 2 is an exemplary view showing a system configuration of the computer 10.

As shown in FIG. 2, the computer 10 includes a central processing unit (CPU) 101, a north bridge 102, a main memory 103, a south bridge 104, and a graphic processing unit (GPU) 105. The computer 10 further includes a video random access memory (VRAM) 105A, a sound controller 106, a Basic Input/Output System read-only memory (BIOS-ROM) 107, a LAN controller 108, a hard disk drive (HDD) 109, and an optical disc drive (ODD) 110. The computer 10 further includes a USB controller 111, a wireless communication module 112, various peripheral devices 113, an embedded controller/keyboard controller (EC/KBC) 114, and an electrically erasable programmable ROM (EEPROM) 115.

The CPU 101 is a processor that controls the operation of each component of the computer 10. The CPU 101 executes an operating system (OS) and various application programs loaded from the HDD 109 into the main memory 103. The CPU 101 further executes a BIOS stored in the BIOS-ROM 107. The BIOS is a program for hardware control.

The north bridge 102 is a bridge device that connects a local bus of the CPU 101 and the south bridge 104. The north bridge 102 includes a memory controller that executes access control of the main memory 103. The north bridge 102 includes the function of communicating with the GPU 105 via a serial bus or the like conforming to, for example, the PCI EXPRESS standard.

The GPU 105 is a display controller that controls the LCD 17 used as a display monitor of the computer 10. A display signal generated by the GPU 105 is sent to the LCD 17.

The south bridge 104 controls the various peripheral devices 113 on a Peripheral Component Interconnect (PCI) bus. The south bridge 104 includes an Integrated Drive Electronics (IDE) controller for controlling the HDD 109 and ODD 110. In addition, the south bridge 104 includes the function of communicating with the LAN controller 108, USB controller 111, and the wireless communication module 112.

The sound controller 106, which is a sound source device, outputs audio data to be reproduced to the speakers 18A, 18B. The LAN controller 108 is a wired communication device that executes wire communication complying with, for example, the IEEE 802.3 standard. The USB controller 111 executes communication with an external device (which is connected via the USB connector 19) conforming to, for example, the USB 2.0 standard.

The wireless communication module 112 includes an antenna terminal for transmitting and receiving a radio-frequency (RF) signal. The signal line 2 is connected to the antenna terminal. The wireless communication module 112 is coupled with the antenna device 1 via the signal line 2.

The EC/KBC 114 is a single-chip microcomputer into which an embedded controller for power management and a keyboard controller for controlling the keyboard 13 and touchpad 16 have been integrated. The EC/KBC 114 includes the function of turning on or off the computer 10 according to the user operation of the power button 14.

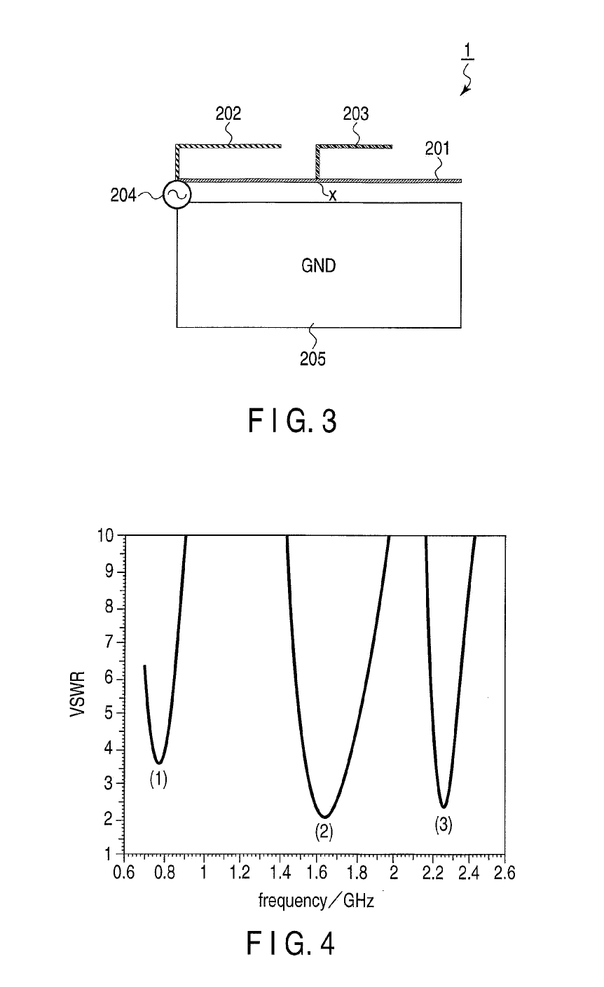

Next, the configuration of the antenna device 1 of the embodiment mounted on the computer 10 which has the aforementioned system configuration will be explained. FIG. 3 is an exemplary view showing a configuration of the antenna device 1.

In FIG. 3, reference numbers 201, 202, 203 indicate antenna elements. Reference number 201 is referred to as a first element, 202 as a second element, and 203 as a third element. Reference number 204 indicates a feeding point and 205 an antenna ground (earth conductor: GND).

As shown in FIG. 3, in the antenna device 1, the first element 201 and second element 202 are connected to the feeding point 204. In addition, the third element 203 is connected to the first element 201 connected to the feeding point 204 at a branch point x. The antenna device 1 includes the third element 203 added to a halfway point (branch point x) of the first element 201, thereby enabling the first to third resonant frequencies to be adjusted independently. This will be explained in detail below.

The length of each of the first element 201, second element 202, and third element 203 is set so as to satisfy the following requirements (1 to 3): (1) the length of the first element is about ¼ the wavelength of the first resonant frequency, (2) the length of the second element is about ¼ the wavelength of the second resonant frequency, and (3) the length from the tip of the first element to the tip of the third element via the branch point x is about ½ the wavelength of the third resonant frequency.

FIG. 4 is an exemplary view showing a characteristic (VSWR) of the antenna device 1. In FIG. 4, the abscissa represents frequency and the ordinate represents VSWR.

As described above, the antenna device 1 covers the first to third resonant frequency bands. In FIG. 4, (1) indicates the first resonant frequency, (2) the second resonant frequency, and (3) the third resonant frequency.

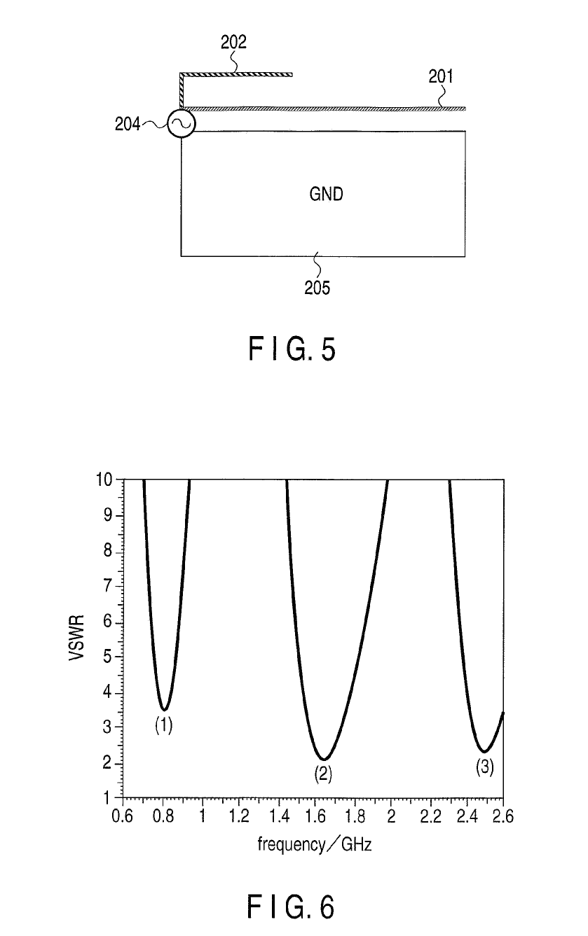

The configuration of a general antenna device which covers a first to a third resonant frequency band (without a third element) is shown in FIG. 5 in comparison with the antenna device 1 of the embodiment. A characteristic (VSWR) of the general antenna device is shown in FIG. 6. In FIG. 5, the same modules as those in the antenna device 1 of the embodiment are indicated by the same reference numbers. As in the antenna device 1 of the embodiment shown in FIG. 4, in FIG. 6, (1) indicates the first resonant frequency, (2) the second resonant frequency, and (3) the third resonant frequency.

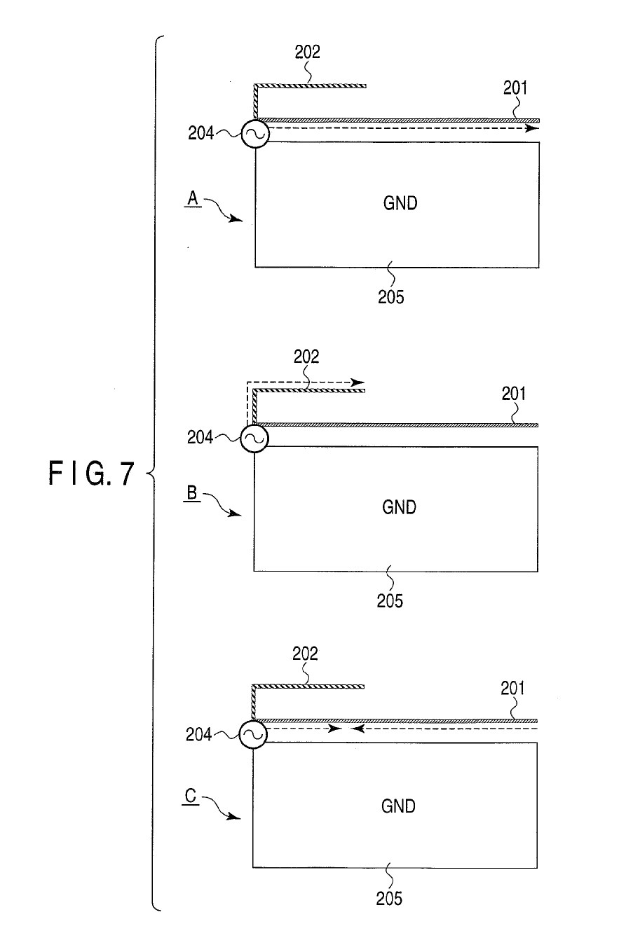

FIG. 7 is an exemplary view showing current distribution for the antenna element at each resonant frequency in the general antenna device (without a third element). In FIG. 7, “A” shows current distribution at the first resonant frequency, “B” shows current distribution at the second resonant frequency, and “C” shows current distribution at the third resonant frequency. An (dashed) arrow indicates the direction of current.

As shown in FIG. 7, at the first resonant frequency [A], current flow for the general antenna device is mostly over the first element 201. At the second resonant frequency [B], current flow for the general antenna device is mostly over the second element 202. At the third resonant frequency [C], current flow for the general antenna device is mostly over the first element 201. The third resonant frequency is a triple harmonic of the first resonant frequency.

Therefore, when the length of the first element 201 is changed, not only the first resonant frequency but also the third resonant frequency changes. That is, the general antenna device cannot adjust the first resonant frequency and third resonant frequency independently.

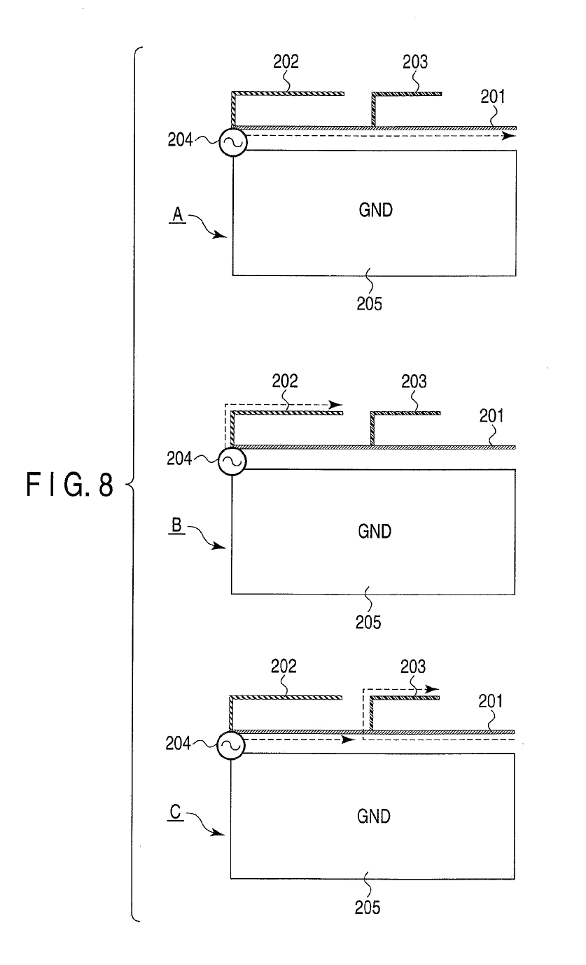

FIG. 8 is an exemplary view showing current distribution for the antenna element at each resonant frequency in the antenna device 1 of the embodiment (with the third element 203 added). In FIG. 8, “A” shows current distribution at the first resonant frequency, “B” shows current distribution at the second resonant frequency, and “C” shows current distribution at the third resonant frequency. The (dashed) arrow indicates the direction of the current.

As shown in FIG. 8, at the first resonant frequency [A], current flow for the antenna device 1 is mostly over the first element 201. At the second resonant frequency [B], current flow for the antenna device 1 is mostly over the second element 202. At the third resonant frequency [C], current flow for the antenna device 1 is mostly over the first element 201 and third element 203.

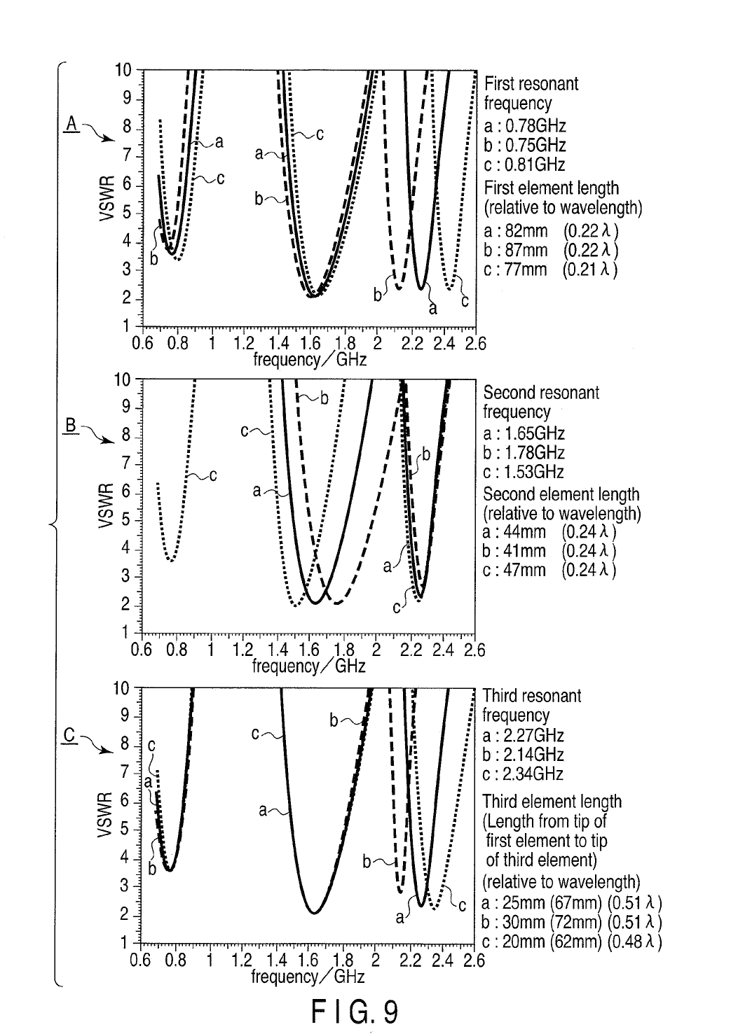

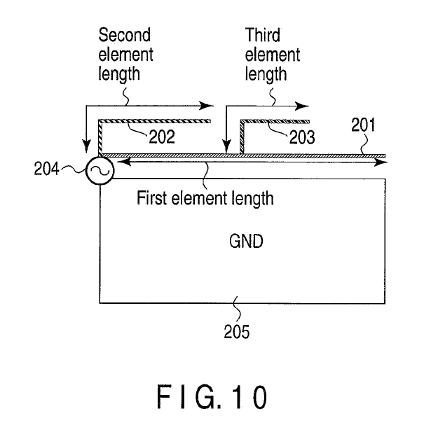

FIG. 9 is an exemplary view showing a characteristic (VSWR) of the antenna device 1 of the embodiment when the length of each of the elements (201, 202, 203) is changed. In FIG. 9, “first element length,” “second element length,” and “third element length” refer to the length of the first element 201, second element 202, and third element 203, respectively, as shown in FIG. 10.

In FIG. 9, “A” indicates a case where only the length of the first element 201 was changed, “B” indicates a case where only the length of the second element 202 was changed, “C” indicates a case where only the length of the third element 203 was changed. In FIG. 9, suppose the distance from the tip of the first element 201 to the branch point to which the third element 203 is connected is 42 mm.

As shown in “A” of FIG. 9, when only the length of the first element 201 (“first element length”) was changed, the first resonant frequency and third resonant frequency mostly change. As shown in “B” of FIG. 9, when only the length of the second element 202 (“second element length”) was changed, only the second resonant frequency mostly changes. As shown in “C” of FIG. 9, when only the length of the third element 203 (“third element length”) was changed, only the third resonant frequency mostly changes.

Therefore, with the configuration of the antenna device 1 of the embodiment (to which the third element 203 has been added), the first to third resonant frequencies can be adjusted independently by adjusting the length of each of the elements (201, 202, 203).

The length of the first element 201 is about ¼ the wavelength of the first resonant frequency, the length of the second element 202 is about ¼ the wavelength of the second resonant frequency, and the length from the tip of the first element 201 to the tip of the third element 203 via the branch point x is about ½ the wavelength of the third resonant frequency.

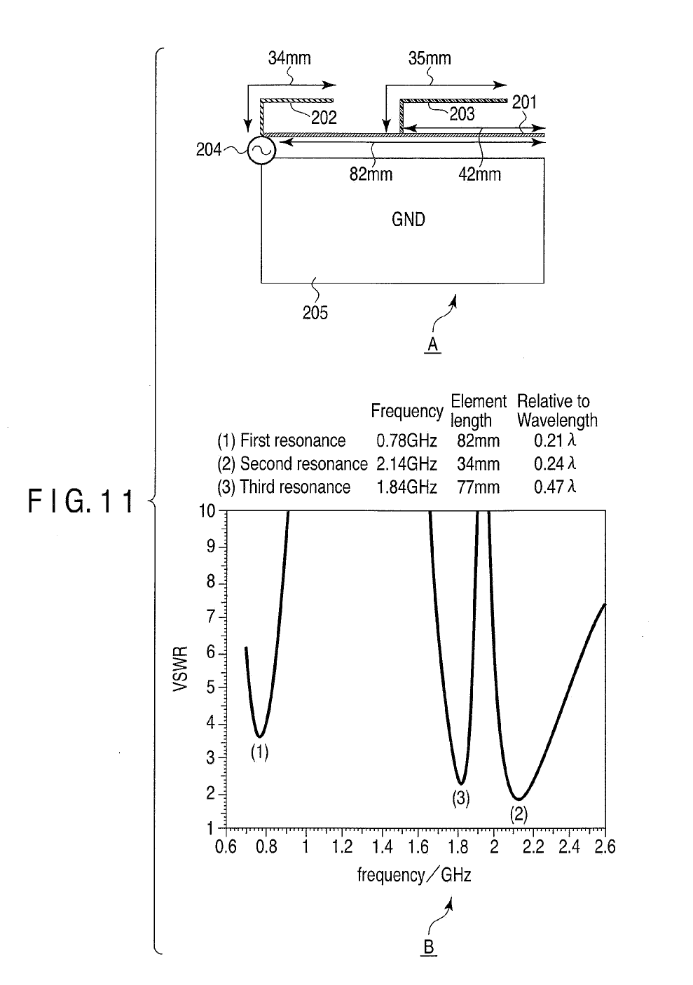

Next, a case where the second resonant frequency is made higher than the third resonant frequency will be explained with reference to FIG. 11.

As shown in “A” of FIG. 11, let the length of the first element 201 be 82 mm, the length of the second element 202 be 34 mm, the length of the third element 203 be 35 mm, and the distance from the tip of the first element 201 to the branch point x to which the third element 302 has been connected be 42 mm. In this case, a characteristic (VSWR) of the antenna device 1 is shown in “B” of FIG. 11. In “B” of FIG. 11, (1) indicates a first resonant frequency, (2) a second resonant frequency, and (3) a third resonant frequency.

As shown in “B” of FIG. 11, the first resonant frequency generated by the first element 201 appears mostly at about 800 MHz. The second resonant frequency generated by the second element 202 appears mostly at about 2.1 GHz. The third resonant frequency generated by the third element 203 appears mostly at about 1.8 GHz.

In the case of FIG. 11, too, the length of the first element 201 is about ¼ the wavelength of the first resonant frequency, the length of the second element 202 is about ¼ the wavelength of the second resonant frequency, and the length from the tip of the first element 201 to the tip of the third element 203 via the branch point x is about ½ the wavelength of the third resonant frequency.

As described above, with the antenna device 1 of the embodiment, the second resonant frequency and the third resonant frequency can be replaced with each other by adjusting the length of the second element 202 and that of the third element 203.

Therefore, with the antenna device 1 of the embodiment, the first to third resonant frequencies can be adjusted independently by adding the third element 203 to a halfway point (or branch point x) of the first element 201. That is, a small, easy-to-adjust antenna device 1 can be realized.

While in the explanation, the configuration of FIG. 3 has been shown as a configuration of the antenna device 1 of the embodiment where the third element 203 has been added to a halfway point (branch point x) of the first element 201, it is not limited to this and may be modified in various ways.

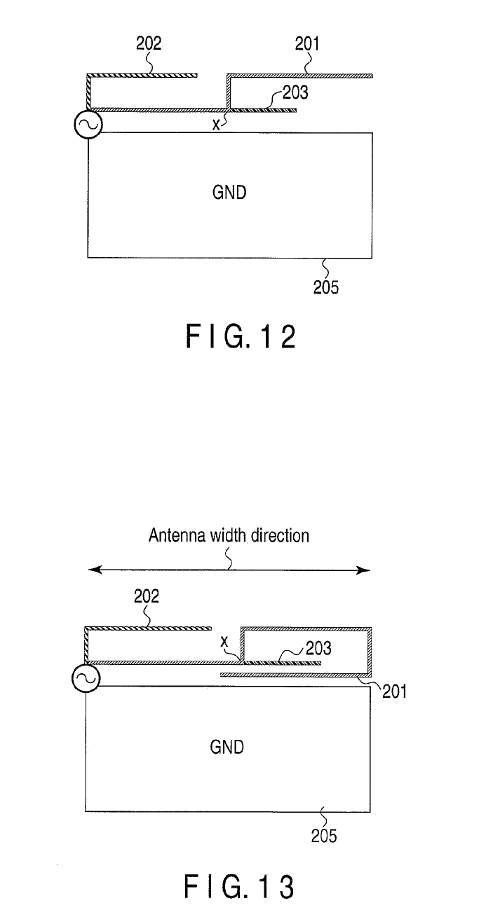

For example, as shown in FIG. 12, the first element 201 may be bent at a branch point x with the third element 203 in a direction in which the element 201 gets away from GND 205 and then, for example, the third element 203 may be located at the collinear position as the unbent first element 201. In this case, the first element 201 can be separated from GND 205, enabling the antenna characteristic to be improved at about the first resonant frequency.

In addition, as shown in FIG. 13, the tip portion of the first element 201 may be further bent inward so as to enclose, for example, the third element 203. That is, the tip portion of the first element 201 may be formed into a U shape. In this case, the antenna can be shortened in the width direction, enabling the antenna device 1 to be made more compact.

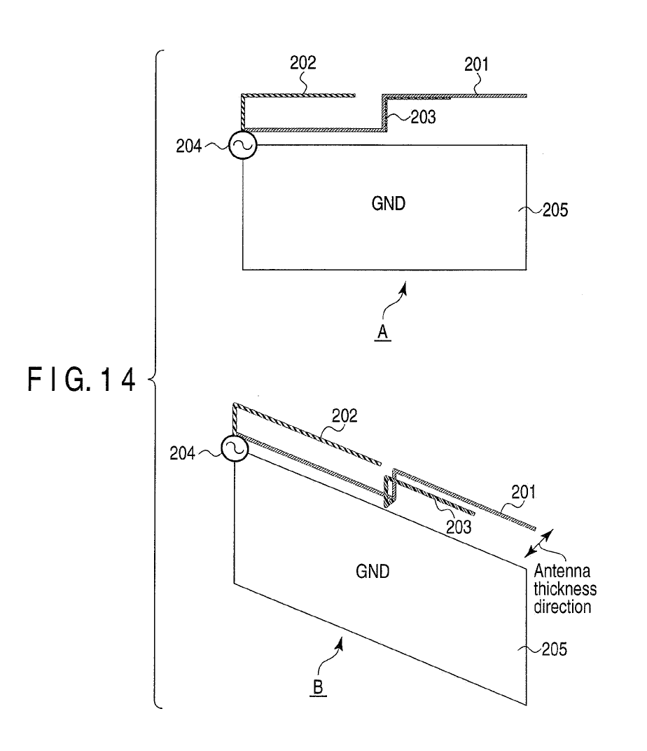

Furthermore, as shown in FIG. 14, the first element 201 and second element 203 may be stacked one on top of the other in a direction of antenna thickness. In this case, both of the tips of the first element 201 and third element 203 can be located away from GND 205, enabling the antenna characteristic to be improved.

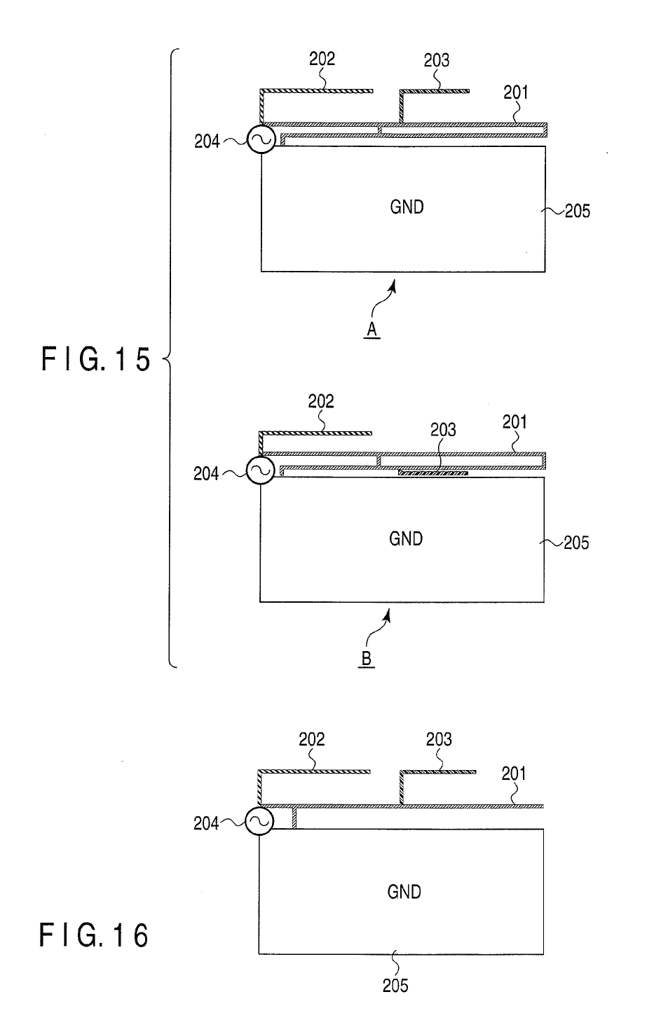

Moreover, as shown in FIG. 15, the first element 201 may be configured to have a turned-back structure (a so-called turned-back antenna). In this case, the impedance can be increased at about the first resonant frequency. Even when the distance between the first element 201 and GND 205 is short, a decrease in the impedance can be alleviated, enabling the antenna characteristic to be improved. In this case, the third element 203 may be arranged on the GND side as shown in “B” of FIG. 15.

Still furthermore, as shown in FIG. 16, like a so-called inverted F antenna, a short-circuit part to GND 205 may be arranged on the first element 201 for impedance adjustment.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An antenna device comprising:
a linear first antenna element comprising a first and second end, the first end connected to a feeding point, the first antenna element comprising a first length;
a linear second antenna element comprising an end mechanically coupled to the feeding point, the second antenna element comprising a second length, the second length shorter than the first length; and
a third antenna element comprising an end connected to the first antenna element, the third antenna element comprising a third length, the third length shorter than the first length.

2. The antenna device of claim 1, wherein:
the first length comprises about ¼ a wavelength of a first resonant frequency and the second length comprises about ¼ a wavelength of a second resonant frequency; and
wherein the antenna device further comprises a fourth length, the fourth length comprising the distance from the second end of the first antenna element to the other end of the third antenna element via a branch point to which the one end of the third antenna element is connected comprises about ½ an wavelength of a third resonant frequency.

3. The antenna device of claim 1, wherein:
the antenna device covers a first resonant frequency, a second resonant frequency and a third resonant frequency;
the first length relates to a wavelength of the first resonant frequency and an wavelength of the third resonant frequency;
the second length relates to a wavelength of the second resonant frequency;
the third length relates to the wavelength of the third resonant frequency; and wherein
adjusting the first, second, or third length adjusts the first resonant frequency, the second resonant frequency or the third resonant frequency respectively to which the first, second, or third length corresponds.

4. The antenna device of claim 1, further comprising a short-circuit portion to an earth conductor, the short-circuit portion on the first antenna element.

5. The antenna device of claim 1, wherein the first antenna element comprises a folded antenna.

6. The antenna device of claim 1, wherein:
the second antenna element comprises a first part and a second part, the first part at one end of the second antenna element and perpendicular to the first antenna element, the second part extending from a dead end of the first part to a second end of the second antenna element, the second part parallel to the first antenna element, and the second part on a same side as the first antenna element; and wherein
the third antenna element comprises a third part and a fourth part, the third part at a first end of the third antenna element and perpendicular to the first antenna element, the fourth part extending from a dead end of the third part to a second end of the third antenna element, the third part parallel to the first antenna element, and the third part on a dead-end side of the first antenna element.

7. The antenna device of claim 6, wherein the third part of the third antenna element is on the same side as the first part of the second antenna element.

8. The antenna device of claim 6, wherein the fourth part of the third antenna element is at a position collinear to the second part of the second antenna element.

9. The antenna device of claim 1, wherein the second length differs from the third length.

10. The antenna device of claim 1, wherein the first antenna element comprises a first part, a second part and a third part, the first part extending from a first end of the first antenna element to a branch point, the third antenna element connected to the branch point, the second part at a dead end of the first part and perpendicular to the first part, the third part extending from a dead end of the second part to a second end of the first antenna element, the third part parallel to and opposite the first part.

11. The antenna device of claim 10, wherein the third antenna element is arranged at the collinear position as the first part of the first antenna element from the branch point.

12. The antenna device of claim 11, wherein the third part of the first antenna element is formed into a U shape, wherein the top portion of the third part is bent inward so as to enclose the third antenna element.

13. The antenna device of claim 10, wherein:
the third antenna element comprises a fourth part and a fifth part, the fourth part arranged at a first end of the third antenna element, the fourth part perpendicular to the first antenna element, the fifth part extending from a dead end of the fourth part to a second end of the third antenna element and formed into a same shape as that of a portion of the first antenna element extending from the branch point to the dead end; and
the third antenna element stacked on the first antenna element in a direction in which the fourth part is arranged.

14. The antenna device of claim 10, wherein the second antenna element comprises a sixth part and a seventh part, the sixth part at a first end of the second antenna element and perpendicular to the first part of the first antenna element, the seventh part extending from a dead end of the sixth part to a second end of the second antenna element, the seventh part parallel to and on the same side as the first part of the first antenna element.

15. The antenna device of claim 14, wherein the seventh part of the second antenna element is arranged at the collinear position as the third part of the first antenna element.

16. The antenna device of claim 1, wherein:
the third antenna element comprises a first part and a second part, the first part at a first end of the third antenna element, the first part perpendicular to the first antenna element, the second part extending from a dead end of the first part to a second end of the third antenna element, the second part formed into the same shape as that of a portion of the first antenna element extending from a branch point to which the first end of the third antenna element is connected; and wherein
the third antenna element is stacked on the first antenna element in a direction in which the first part is arranged.
